(19) United States
(12) Patent Application Publication
(10) Pub. No.: US 2011/0155525 A1
(43) Pub. Date: Jun. 30, 2011

(54) Adjustable brake lever assembly for bicycle

(75) Inventor: Falcon Yang, Taichung (TW)

(73) Assignee: Elf Performance System Co., Ltd.

(21) Appl. No.: 12/655,450

(22) Filed: Dec. 30, 2009

(51) Int. Cl. B62L 3/02

(52) U.S. Cl. 188/344

(57) ABSTRACT

An adjustable brake lever assembly includes a handle mount having a lever housing, a piston of a brake device slidably engaged in the lever housing, a rotary member pivotally coupled to the lever housing, a brake handle includes a mounting arm connected to the rotary member for adjusting the brake handle relative to the rotary member and the lever housing, a barrel is pivotally fitted into the mounting arm, and a link rod is pivotally coupled to the piston of the brake device and includes a threaded segment engaged with the barrel for adjusting the brake handle relative to the brake device and the lever housing and for allowing the brake handle to be operated by adults or children of different hand or palm sizes or dimensions:

### BACKGROUND OF THE INVENTION

1. Field of the Invention

The present invention relates to an adjustable brake lever assembly for a hydraulic disc brake device of a bicycle, and more particularly to an adjustable brake lever assembly including an adjusting structure or mechanism for micro-adjusting the brake lever assembly relative to the handlebar of the bicycle and for allowing the brake lever assembly to be easily. operated by adults or children of different hand or palm sizes or dimensions.

2. Description of the Prior Art

Typical motorcycles or bicycles comprise a brake lever assembly attached to the handlebar of the bicycle for actuating or operating a brake device, such as a hydraulic disc brake device, and the brake lever assembly is normally adjustable relative to the handlebar of the bicycle to fit adults or children of different hand or palm sizes or dimensions and for allowing the brake lever assembly to be easily operated by adults or children.

For example, U.S. Pat. No. 5,448,927 to Lumpkin, U.S. Pat. No. 5,515,743 to Lumpkin, U.S. Pat. No. 5,660,082 to Hsien, U.S. Pat. No. 6,053,068 to Yamashita et al., and U.S. Pat. No. 6,098,488 to Vos disclose several examples of the typical brake lever assemblies of the bicycle adjustable to vary the leverage applied to a bicycle brake device and each including a brake handle having an elongated finger grip and a transverse elongated mounting arm attached to a handle mount for pivotal movement about a fixed axis.

However, the transverse elongated mounting arms are normally pivotally attached to the handle mount with a pivot shaft and may not be adjusted relative to the handle mount such that the typical brake lever assemblies may not be suitably adjusted to the selected or suitable or predetermined position or location relative to the handle mount.

U.S. Pat. No. 7,389,642 to Takizawa et al. discloses another typical brake lever assembly of the bicycle providing two-stage braking by operatively connecting a lever to first and second pistons contained in a master cylinder, in which the first and second pistons are operatively connected to one another such that they move together until the first piston reaches a threshold distance from a top end of the master cylinder.

However, the brake lever of the typical brake lever assembly of the bicycle may not be adjusted relative to the handle mount or the handlebar of the bicycle such that the typical brake lever assembly may not be suitably adjusted to the selected or suitable or predetermined position or location relative to the handle mount or the handlebar of the bicycle.

The present invention has arisen to mitigate and/or obviate the afore-described disadvantages of the conventional adjustable brake lever assemblies.

### SUMMARY OF THE INVENTION

The primary objective of the present invention is to provide an adjustable brake lever assembly including an adjusting structure or mechanism for micro-adjusting the brake lever assembly relative to the handlebar of the bicycle and for allowing the brake lever assembly to be easily operated by adults or children of different hand or palm sizes or dimensions.

In accordance with one aspect of the invention, there is provided an adjustable brake lever assembly comprising a handle mount including a lever housing having an attachment mechanism for attaching to a handlebar of a bicycle, and including a chamber formed in the lever housing, a brake device including a piston slidably engaged in the chamber of the lever housing, a rotary member including a base pivotally coupled to the lever housing with a pivot shaft, and including a threaded shank extended outwardly therefrom, a brake handle including a finger grip bar and a mounting arm connected at a connected portion, and including a pivot hole formed in the connected portion of the brake handle, and including a pivot opening formed in the mounting arm, a knob rotatably fitted into the pivot hole of the brake handle, and including a screw hole formed in the knob for threading and engaging with the threaded shank of the rotary member and for rotating and adjusting the finger grip bar and the mounting arm of the brake handle relative to the rotary member and the lever housing, a barrel pivotally fitted into the pivot opening of the mounting arm, and including a screw hole formed in the barrel, and a link rod including a first end pivotally coupled to the piston of the brake device, and including a threaded segment engaged with the screw hole of the barrel for adjusting the mounting arm of the brake handle relative to the piston of the brake device and the lever housing and for allowing the brake handle to be easily and suitably adjusted relative to the piston of the brake device and the lever housing and thus for allowing the brake lever assembly to be easily operated by adults or children of different hand or palm sizes or dimensions.

The brake handle includes a slot formed in the mounting arm for forming two flaps, and the pivot opening is extended through the flaps of the mounting arm for receiving and engaging with the barrel and thus for pivotally attaching or mounting the barrel to the mounting arm of the brake handle. The screw hole of the barrel is aligned with the slot of the mounting arm.

The handle mount includes a compartment formed in the lever housing and defined between two walls and communicative with the chamber of the lever housing, and includes an orifice extended through the walls of the handle mount for engaging with the pivot shaft and thus for pivotally attaching or mounting the pivot shaft to the lever housing.

The brake handle includes at least one insert fitted into the pivot opening of the mounting arm and engaged with the knob for stably or solidly anchoring and positioning the knob in the pivot hole of the brake handle and for preventing the knob from being moved or disengaged from the brake handle.

The insert includes an aperture formed therein, and the knob includes a protrusion extended outwardly therefrom and engaged with the aperture of the insert for stably or solidly anchoring and positioning the knob in the pivot hole of the brake handle and for preventing the knob from being moved sidewise relative to the brake handle.

The knob includes at least one positioning member formed therein, and the insert includes a positioning element for engaging with the positioning member of the knob and for anchoring and positioning the knob to the brake handle at the suitable or selected angular positions.

The positioning member of the knob is preferably a recess, and the positioning element of the insert is preferably a projection extended from the insert for engaging with the recess of the knob. The first end of the link rod is preferably a ball-shaped or universal joint for pivotally coupling the link rod to the piston of the brake device and thus for allowing the piston of the brake device to be suitably moved or actuated or operated by the brake handle with the link rod.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an adjustable brake lever assembly in accordance with the present invention;

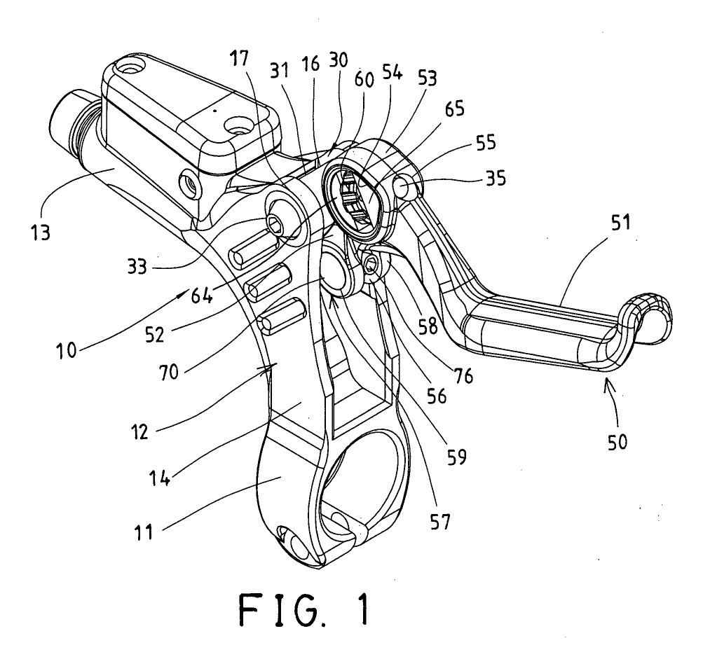

FIG. 2 is a partial exploded view of the adjustable brake lever assembly;

FIG. 3 is a side plan schematic view of the adjustable brake lever assembly, in which a portion of the adjustable brake lever assembly has been cut off for showing the inner structure of the adjustable brake lever assembly; and

FIG. 4 is another side plan schematic view similar to FIG. 3, illustrating the operation of the adjustable brake lever assembly for the bicycle.

### DETAILED DESCRIPTION OF THE PREFERRED EMBODIMENT

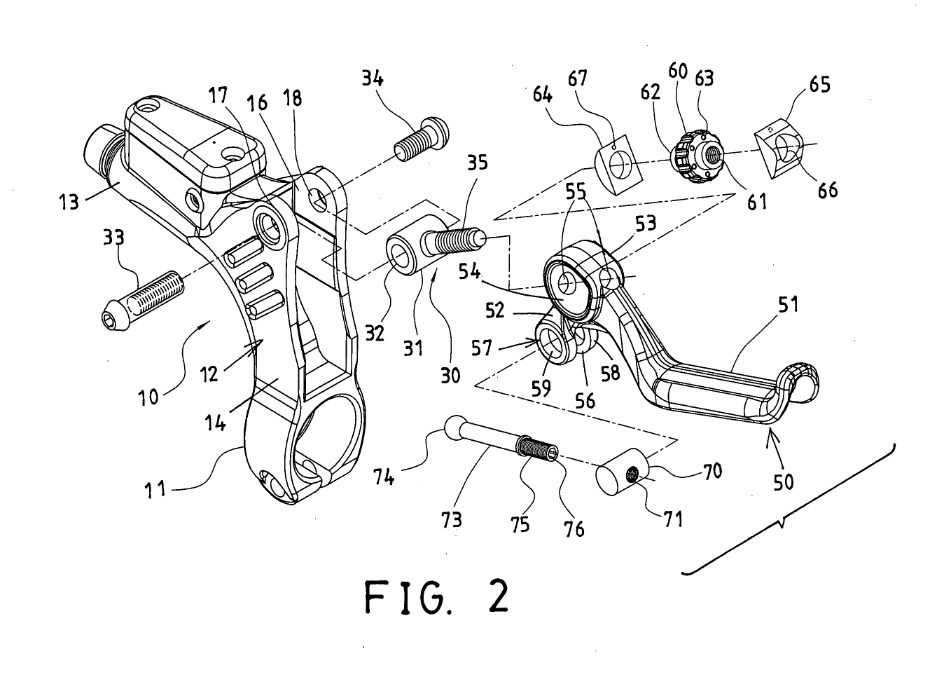

Referring to the drawings, and initially to FIG. an adjustable brake lever assembly in accordance with the present invention comprises a handle mount 10 including a clamp or attachment mechanism 11 formed or provided thereon and configured to be fastened or attached to a handlebar 80 of the bicycle which includes a hand grip 81 for being grasped or held by the user, the handle mount 10 includes a hollow L-shaped lever housing 12 having an integrally formed nose cone 13 and post 14, and includes a fluid chamber 15 formed therein and substantially parallel to the nose cone 13 of the lever housing 12, and a brake device 20, such as a hydraulic disc brake device 20 includes a piston 21 slidably engaged within the fluid chamber 15 of the lever housing 12 for actuating or operating the brake device 20. The lever housing 12 of the handle mount 10 includes a space or compartment 16 formed therein and formed or defined between two side walls 17 and communicative with the fluid chamber 15 of the lever housing 12, in which the walls 17 each include an orifice 18 formed therein (FIG. 2) and the orifices 18 of the walls 17 are coaxial, or the orifice 18 is extended through the walls 17 of the handle mount 10.

A rotary member 30 includes a block or base 31 disposed or engaged into the compartment 16 of the lever housing 12 and disposed or positioned between the walls 17 and having a bore 32 formed in the base 31 and aligned with the orifices 18 of the walls 17 for receiving or engaging with a pivot shaft 33 and for pivotally or rotatably coupling or attaching or mounting the base 31 of the rotary member 30 to the lever housing 12, and one or more fasteners 34 may further be provided and engaged with the pivot shaft 33 and the lever housing 12 for solidly or stably securing the base 31 of the rotary member 30 to the lever housing 12. The rotary member 30 further includes a threaded shank 35 extended outwardly therefrom and substantially perpendicular to the base 31 of the rotary member 30 and/or the pivot shaft 33.

A brake handle 50 includes a finger grip bar 51 configured to be comfortably embraced by the fingers of a rider and an integrally formed or connected mounting arm 52, in which the finger grip bar 51 and the mounting arm 52 are connected at their proximal ends or at a connected portion 53; and includes a pivot hole 54 formed in the finger grip bar 51 and/or the mounting arm 52, or formed in the proximal ends or connected portion 53 of the finger grip bar 51 and the mounting arm 52, and further includes a channel 55 formed in the finger grip bar 51 and/or the mounting arm 52, or formed in the proximal ends or connected portion 53 of the finger grip bar 51 and the mounting arm 52 and intersecting or communicating with the pivot hole 54 of the finger grip bar 51 and/or the mounting arm 52, or of the brake handle 50 for receiving or engaging with the threaded shank 35 of the rotary member 30, and further includes a gap or slot 56 formed in the other end or free end 57 of the mounting arm 52 for forming or defining two flaps 58, and a pair of coaxial pivot openings 59 extended through the flaps 58 of the mounting arm 52.

A control knob 60 is pivotally or rotatably engaged or fitted into the pivot hole 54 of the finger grip bar 51 and/or the mounting arm 52, or of the brake handle 50, and includes a screw hole 61 formed therein for threading or engaging with the threaded shank 35 of the rotary member 30 and for rotating and adjusting the finger grip bar 51 and/or the mounting arm 52 of the brake handle 50 toward or away from or relative to the rotary member 30 and the lever housing 12. It is preferable that the knob 60 includes a protruding stem or two protrusions 62 oppositely extended outwardly therefrom, and includes a number of positioning members 63, such as projections or recesses 63 formed in the outer peripheral portion thereof.

One or more (such as two) inserts 64, 65 may further be provided and engaged with or into the pivot hole 54 of the finger grip bar 51 and/or the mounting arm 52, or of the brake handle 50; and each include an aperture 66 formed therein for engaging with the protrusions 62 of the knob 60 and for solidly or stably anchoring or positioning or securing the knob 60 in the pivot hole 54 of the finger grip bar 51 and/or the mounting arm 52, or of the brake handle 50, and each include a positioning element 67, such as a recess or a projection 67 formed or extended outwardly therefrom for engaging with either of the recesses or positioning members 63 of the knob 60 and for anchoring or positioning the knob 60 to the finger grip bar 51 and/or the mounting arm 52 of the brake handle 50 at selected angular positions, and/or for anchoring or positioning the brake handle 50 to the lever housing 12 at the adjusted positions or locations.

A cylinder or barrel 70 is pivotally or rotatably engaged or fitted into the pivot openings 59 of the flaps 58 of the mounting arm 52, and includes a screw hole 71 formed therein and aligned with or communicative with the slot 56 of the mounting arm 52. A link rod 73 includes a ball-shaped or universal joint 74 formed or provided on one end or first end 74 thereof and pivotally or rotatably coupled to the piston 21 of the brake device 20, and includes a threaded segment 75 formed or provided on the other end thereof for threading or engaging with the screw hole 71 of the cylinder or barrel 70 and for adjusting the other end or free end 57 of the mounting arm 52 of the brake handle 50 toward or away from or relative to the piston 21 of the brake device 20 and the lever housing 12.

The link rod 73 includes a non-circular engaging cavity 76 formed or provided in the other end or free end thereof for engaging with the wrenches or other driving tools (not shown) and for rotating the link rod 73 relative to the barrel 70 and the mounting arm 52 of the brake handle 50, and thus for adjusting the other end or free end 57 of the mounting arm 52 of the brake handle 50 toward or away from or relative to the piston 21 of the brake device 20 and the lever housing 12, in order to further adjust the finger grip bar 51 and the brake handle 50 relative to the lever housing 12 and the hand grip 81 of the handlebar 80 and thus for allowing the finger grip bar 51 of the brake handle 50 to be easily held or grasped or operated by adults or children of different hand or palm sizes or dimensions.

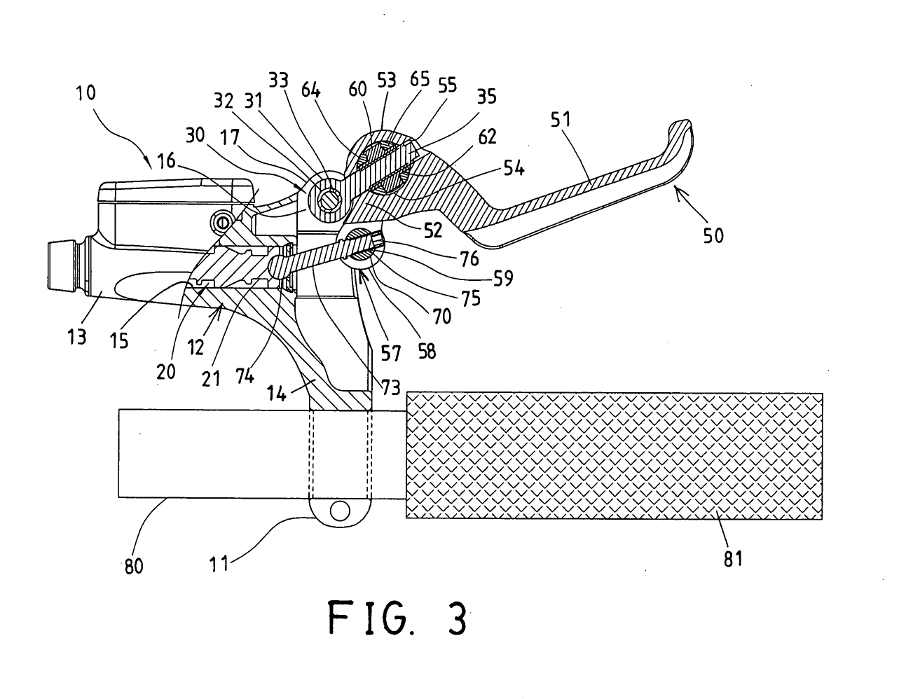

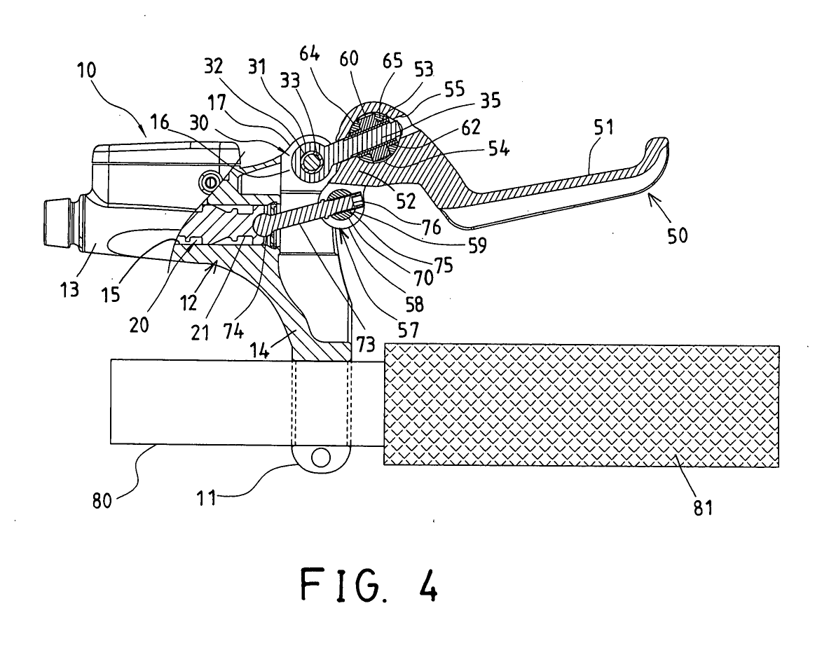

In operation, as shown in FIGS. 3 and 4, the proximal ends or connected portion 53 of the finger grip bar 51 and the mounting arm 52, or of the brake handle 50 may be moved or adjusted toward or away from or relative to the rotary member 30 and the lever housing 12 by rotating the knob 60 relative to the brake handle 50 and the threaded shank 35 of the rotary member 30 in order to further adjust the finger grip bar 51 and/or the mounting arm 52 of the brake handle 50 relative to the lever housing 12 and the hand grip 81 of the handlebar 80. The other end or free end 57 of the mounting arm 52 of the brake handle 50 may also be moved or adjusted toward or away from or relative to the piston 21 of the brake device 20 and the lever housing 12 by rotating the link rod 73 relative to the barrel 70 and the mounting arm 52 of the brake handle 50 in order to further adjust the finger grip bar 51 and the brake handle 50 relative to the lever housing 12 and the hand grip 81 of the handlebar 80 and thus for adjusting the actuation or operation to the piston 21 of the brake device 20.

Accordingly, the adjustable brake lever assembly in accordance with the present invention includes an adjusting structure or mechanism for micro-adjusting the brake lever assembly relative to the handlebar of the bicycle and for allowing the brake lever assembly to be easily operated by adults or children of different hand or palm sizes or dimensions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable brake lever assembly comprising:
a handle mount including a lever housing having an attachment mechanism for attaching to a handlebar of a bicycle, and including a chamber formed in said lever housing,
a brake device including a piston slidably engaged in said chamber of said lever housing,
a rotary member including a base pivotally coupled to said lever housing with a pivot shaft, and including a threaded shank extended outwardly therefrom,
a brake handle including a finger grip bar and a mounting arm connected at a connected portion, and including a pivot hole formed in said connected portion of said brake handle, and including a pivot opening formed in said mounting arm,
a knob rotatably fitted into said pivot hole of said brake handle, and including a screw hole formed in said knob for threading and engaging with said threaded shank of said rotary member and for rotating and adjusting said finger grip bar and said mounting arm of said brake handle relative to said rotary member and said lever housing,
a barrel pivotally fitted into said pivot opening of said mounting arm, and including a screw hole formed in said barrel, and
a link rod including a first end pivotally coupled to said piston of said brake device, and including a threaded segment engaged with said screw hole of said barrel for adjusting said mounting arm of said brake handle relative to said piston of said brake device and said lever housing.

2. The adjustable brake lever assembly as claimed in claim 1, wherein said first end of said link rod is a ball-shaped or universal joint.

3. The adjustable brake lever assembly as claimed in claim 1, wherein said brake handle includes a slot formed in said mounting arm for forming two flaps, and said pivot opening is extended through said flaps of said mounting arm for receiving and engaging with said barrel.

4. The adjustable brake lever assembly as claimed in claim 3, wherein said screw hole of said barrel is aligned with said slot of said mounting arm.

5. The adjustable brake lever assembly as claimed in claim 1, wherein said handle mount includes a compartment formed in said lever housing and defined between two walls and communicative with said chamber of said lever housing, and includes an orifice extended through said walls of said handle mount for engaging with said pivot shaft.

6. The adjustable brake lever assembly as claimed in claim 1, wherein said brake handle includes at least one insert fitted into said pivot opening of said mounting arm and engaged with said knob for anchoring and positioning said knob in said pivot hole of said brake handle.

7. The adjustable brake lever assembly as claimed in claim 6, wherein said at least one insert includes an aperture formed therein, and said knob includes a protrusion extended outwardly therefrom and engaged with said aperture of said at least one insert.

8. The adjustable brake lever assembly as claimed in claim 6, wherein said knob includes at least one positioning member formed therein, and said at least one insert includes a positioning element for engaging with said at least one positioning member of said knob and for anchoring and positioning said knob to said brake handle.

9. The adjustable brake lever assembly as claimed in claim 8, wherein said at least one positioning member of said knob is a recess, and said positioning element of said at least one insert is a projection extended from said at least one insert.
